(19) United States
(12) Patent Application Publication
(10) Pub. No.: US 2014/0312855 A1
(43) Pub. Date: Oct. 23, 2014

(54) MULTI-PURPOSE POWER MANAGEMENT CHIP AND POWER PATH CONTROL CIRCUIT

(71) Applicant: Nien-Hui Kung, HsinChu (TW)

(72) Inventor: Nien-Hui Kung, HsinChu (TW)

(73) Assignee: RICHTEK TECHNOLOGY CORPORATION, Chupei City (TW)

(21) Appl. No.: 13/865,561

(22) Filed: Apr. 18, 2013

(51) Int. Cl. H02J 7/00

(52) U.S. Cl. CPC H02J 7/0072
USPC 320/163

(57) ABSTRACT

The present invention discloses a multi-purpose power management chip and a power path control circuit. The multi-purpose power management chip includes: a switch circuit including at least one power transistor; a switch control circuit for generating a first switch signal to control an operation of the power transistor to thereby control the power conversion between an input terminal and an output terminal; a power path management circuit for controlling the charging operation from the output terminal to the battery; a current source for supplying a current to the battery; and a path selection circuit for determining whether the charging operation to the battery is controlled by the power path management circuit and the current source or not according to whether a power path power transistor is provided on the power path or not.

### BACKGROUND OF THE INVENTION

1. Field of Invention

The present invention relates to a multi-purpose power management chip and a power path control circuit; particularly, it relates to such multi-purpose power management chip and power path control circuit that can automatically determine whether to enable a power path management circuit and a current source according to the connection relationship between a system load and a battery, such that the chip and the control circuit can be applied to different types of applications regardless whether the system load is directly or indirectly connected to the battery.

2. Description of Related Art

FIG. 1 shows a schematic diagram of a conventional power supply system. Referring to FIG. 1, the power supply system 10 includes a switching regulator 1a which converts external power from an input terminal Vin to an output terminal Vsys. The output terminal Vsys supplies power to the system load (which is, for example, a computer host) and charges a battery Bat. When the input terminal Vin is disconnected from the external power, the battery Bat will output power to the output terminal Vsys. A feedback circuit 13 includes two resistors R1 and R2 connected to each other in series. One terminal of the resistor R1 is coupled to the output voltage Vsys, and one terminal of the resistor R2 is coupled to the ground. A feedback signal FB1 is extracted from the voltage difference across the resistor R2. An error amplifier 11 receives the feedback signal FB1, and compares the feedback signal FB1 with a reference voltage Vref1 to generate an error signal Comp1 as the input of a pulse width modulation (PWM) signal generator 12. According to the error signal Comp1, the PWM signal generator 12 generates a switch signal to control a power transistor HS and a power transistor LS. By the operations of the power transistors HS and LS, the input voltage at the input terminal Vin is converted to the output voltage at the output terminal Vsys through an inductor L. The power transistors HS and LS form a switch circuit 14. In order to control the charging current from the output terminal Vsys to the battery Bat, a sensing resistor RS is disposed between the output terminal Vsys and the battery Bat. An error amplifier 16 detects the voltage difference across the sensing resistor RS and sends it as an input to the PWM signal generator 12, and thereby the charging current to the battery Bat is controlled within a predetermined range. In such prior art, the error amplifier 11, the PWM signal generator 12, the switch circuit 14 and the error amplifier 16 are usually integrated into a chip. However, the chip is only suitable for the configuration where the battery Bat is directly connected to the output terminal Vsys through the sensing resistor RS, as shown in FIG. 1, but it is not suitable for a power supply system of another configuration, such as the one shown in FIG. 2 below.

FIG. 2 shows a schematic diagram of another conventional power supply system. Referring to FIG. 2, the power supply system 20 comprises a switching regulator 1a, a charging management circuit 2a, a battery Bat and a PMOS transistor 27. The switching regulator 1a converts external power from an input terminal Vin to an output terminal Vsys. The output terminal Vsys supplies power to the system load (which is, for example, a computer host) and charges the battery Bat. When the input terminal Vin is disconnected from the external power, the battery Bat will output power to the output terminal Vsys. The power supply system 20 detects whether the battery Bat needs to be charged or it has been fully charged, and controls the PMOS transistor 27 accordingly to thereby control the charging current flowing to the battery Bat.

A feedback circuit 26 includes two resistors R3 and R4 connected to each other in series. One terminal of the resistor R3 is coupled to the battery voltage Vbat of the battery Bat, and one terminal of the resistor R4 is coupled to the ground. A feedback signal FB2 is extracted from the voltage difference across the resistor R4. An error amplifier 21 receives the feedback signal FB2, and compares the feedback signal FB2 with a reference voltage Vref2 to generate an error signal Comp2. An error amplifier 24 detects the voltage difference across the sensing resistor RS and outputs an error signal Comp4. An error amplifier 23 compares the error signal Comp4 with a reference voltage Vref3 to output an error signal Comp3. According to the error signal Comp2 and the error signal Comp3, the charging controller 22 determines whether the battery Bat needs to be charged or it has been fully charged, and determines to turn ON or turn OFF the PMOS transistor 27 accordingly.

In such prior art, the error amplifier 11, the PWM signal generator 12, the switch circuit 14, the error amplifiers (21, 23, and 24) and the charging controller 22 are usually integrated into a chip 2d. However, the chip 2d is only suitable for the configuration where the battery Bat is connected to the output terminal Vsys through the sensing resistor RS and the PMOS transistor 27, as shown in FIG. 2, but it cannot be applied to a power supply system of another configuration, such as the one without the power transistor 27 as shown in FIG. 1.

In view of the above, to overcome the drawbacks in the prior art, the present invention proposes a multi-purpose power management chip and a power path control circuit. Such multi-purpose power management chip and power path control circuit can automatically determine whether to enable a power path management circuit and a current source according to the connection relationship between a system load and a battery, such that the chip and the control circuit can be applied to different types of applications regardless whether the system load is directly or indirectly connected to the battery through a switch.

### SUMMARY OF THE INVENTION

A first objective of the present invention is to provide a multi-purpose power management chip.

A second objective of the present invention is to provide a power path control circuit.

To achieve the above and other objectives, from one perspective, the present invention provides a multi-purpose power management chip for controlling power conversion from an input terminal to an output terminal and for controlling a charging operation to a battery from the output terminal, the multi-purpose power management chip comprising: a switch circuit including at least one power transistor; a switch control circuit for generating a first switch signal which controls an operation of the power transistor to thereby control the power conversion from the input terminal to the output terminal; a power path management circuit for controlling the charging operation from the output terminal to the battery; a current source for supplying a current to the battery to charge the battery; and a path selection circuit for determining whether the charging operation to the battery is controlled by the power path management circuit and the current source or not; wherein: when the output terminal is coupled to the battery through a power path power transistor, the path selection circuit designates the power path management circuit to control the power path power transistor, thereby controlling the charging operation to the battery; and when the output terminal is not coupled to the battery through the power path power transistor, the path selection circuit selects the switch control circuit to receive information related to a battery voltage of the battery.

In one embodiment, when the output terminal is coupled to the battery through the power path power transistor and when the battery voltage of the battery is smaller than a predetermined level, the power path management circuit turns OFF the power path power transistor; and when the output terminal is coupled to the battery through the power path power transistor and when the battery voltage of the battery is larger than or equal to the predetermined level, the power path management circuit turns ON the power path power transistor.

In one embodiment, when the battery voltage of the battery is smaller than the predetermined level and when the power path power transistor is turned OFF, the current source is turned ON to supply the current to the battery; and when the battery voltage of the battery is larger than or equal to the predetermined level and when the power path power transistor is turned ON, the current source is turned OFF.

In one embodiment, when the output terminal is not coupled to the battery through the power path power transistor, the current source is turned OFF.

In one embodiment, the path selection circuit includes a multiplexer which determines whether the charging operation to the battery is controlled by the power path management circuit and the current source or not according to an external setting signal.

In one embodiment, the path selection circuit includes: a detection signal generator for generating a detection voltage according to whether the power path power transistor is disposed for comparing the detection voltage with a reference voltage; and a multiplexer for determining whether the charging operation to the battery is controlled by the power path management circuit and the current source according to an output from the comparator.

In one embodiment, the power path management circuit includes: a first error amplifier for comparing a first feedback signal related to the battery voltage with a first reference voltage to generate a first error signal, wherein the path selection circuit determines whether to transmit the first error signal to the switch control circuit or the power path management circuit; and a second error amplifier for comparing information related to the battery charging current with a second reference voltage to generate a second error signal.

In the above-mentioned embodiment, the power path management circuit preferably further includes a power path controller; when the path selection circuit determines to transmit the first error signal to the power path management circuit, the power path controller generates a second switch signal which controls an operation of the power path power transistor; when the path selection circuit does not determine to transmit the first error signal to the power path management circuit, the power path controller does not generate the second switch signal which controls the operation of the power path power transistor.

In the above-mentioned embodiment, the switch control circuit preferably includes: a third error amplifier for comparing a second feedback signal related to an output voltage at the output terminal with a third reference voltage to generate a third error signal; and a pulse width modulation (PWM) signal generator, wherein: when the path selection circuit determines to transmit the first error signal to the power path management circuit, the PWM signal generator generates the first switch signal according to the second error signal and the third error signal; and when the path selection circuit determines to transmit the first error signal to the switch control circuit, the PWM signal generator generates the first switch signal according to the first error signal and the second error signal and the third error signal.

From another perspective, the present invention provides a power path control circuit for selecting at least one control loop according to a connection relationship between an output terminal and a battery, the power path control circuit comprising: a power path management circuit for controlling a charging operation to the battery from an output voltage at the output terminal, wherein the output voltage is converted from an input voltage at an input terminal through a switching regulator; a current source for supplying a current to the battery to charge the battery; and a path selection circuit for determining whether the charging operation to the battery is controlled by the power path management circuit and the current source or not according to whether a power path power transistor is disposed between the output terminal and the battery; wherein: when the output terminal is coupled to the battery through the power path power transistor, the path selection circuit designates the power path management circuit to control the power path power transistor, thereby controlling the charging operation to the battery; and when the output terminal is not coupled to the battery through the power path power transistor, the path selection circuit selects the switching regulator to receive information related to a battery voltage of the battery.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a conventional power supply system.

FIG. 2 shows a schematic diagram of another conventional power supply system.

FIG. 3 shows a schematic diagram of an embodiment of the present invention, illustrating a multi-purpose power management chip applied to a power supply system.

FIG. 4 shows a schematic diagram of the multi-purpose power management chip in FIG. 3 applied to another power supply system.

FIG. 5 shows another embodiment of the power transistor HS.

FIG. 6 shows another embodiment of the path selection circuit 3c.

FIGS. 7A-7B show two embodiments illustrating examples of the detection signal generator 33.

FIGS. 8A-8B show two other embodiments illustrating examples of the detection signal generator 33.

### DESCRIPTION OF THE PREFERRED EMBODIMENTS

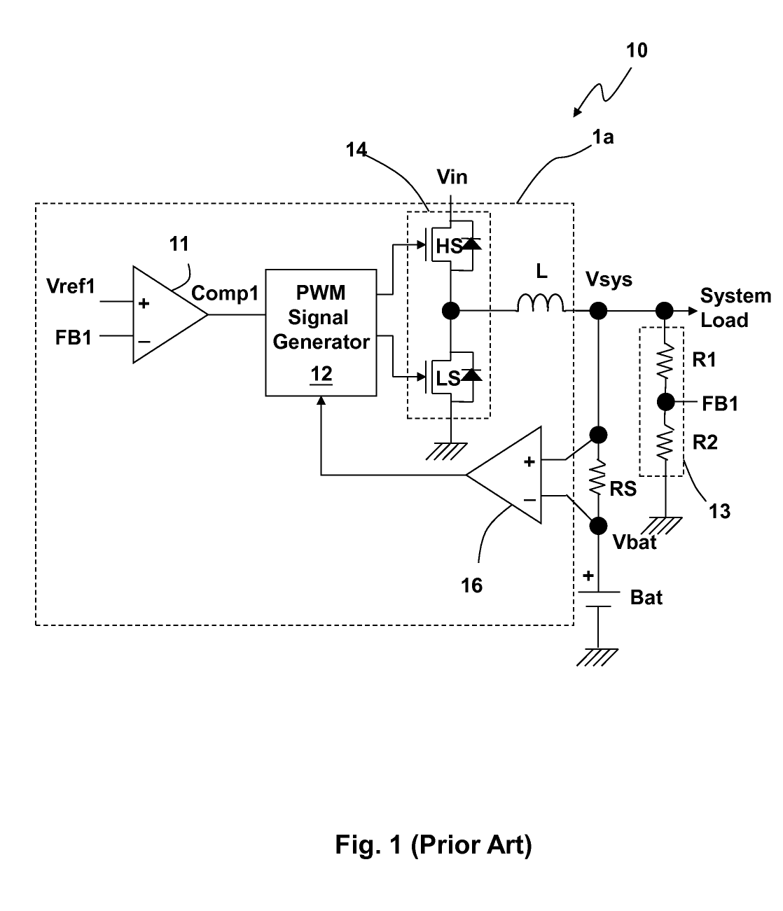

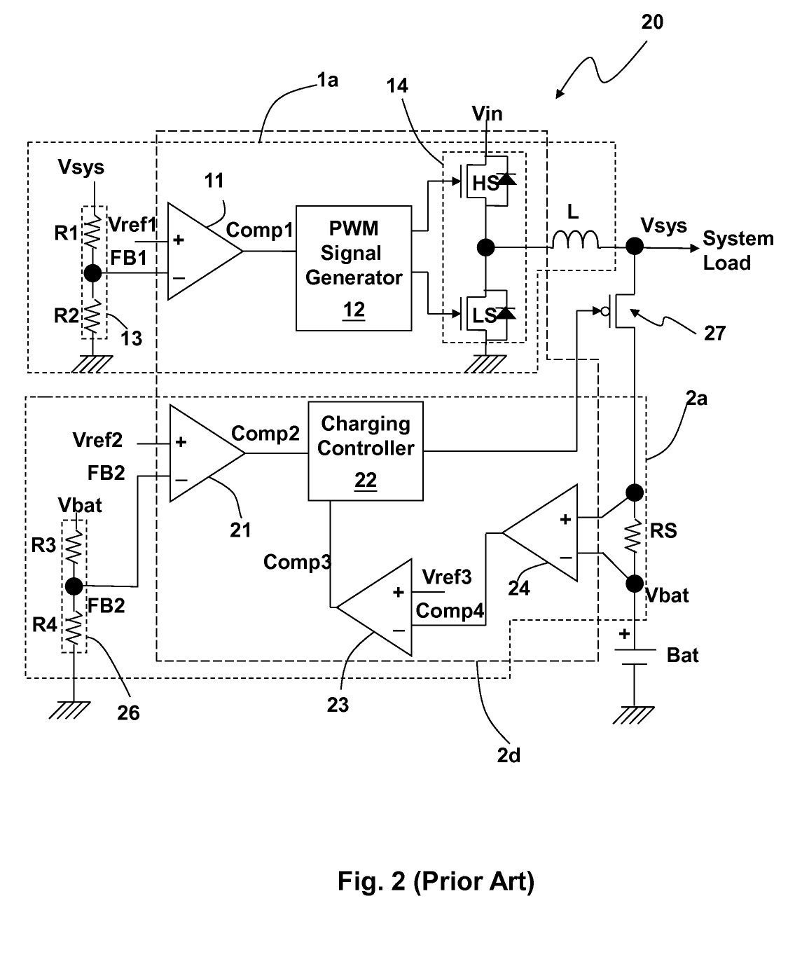

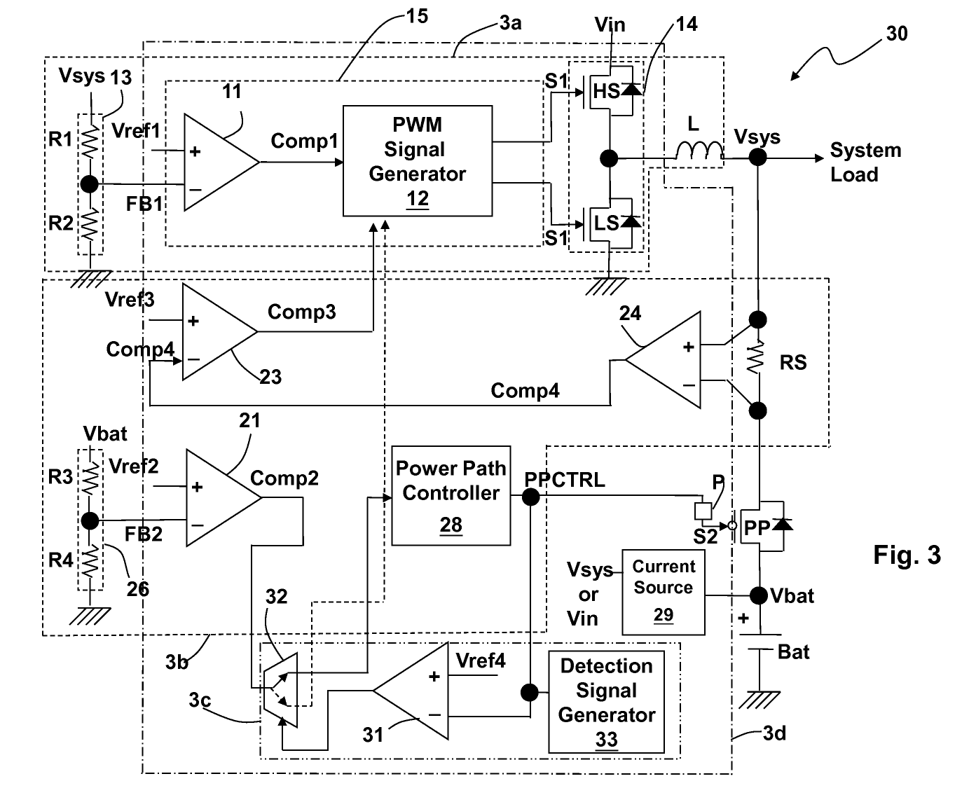

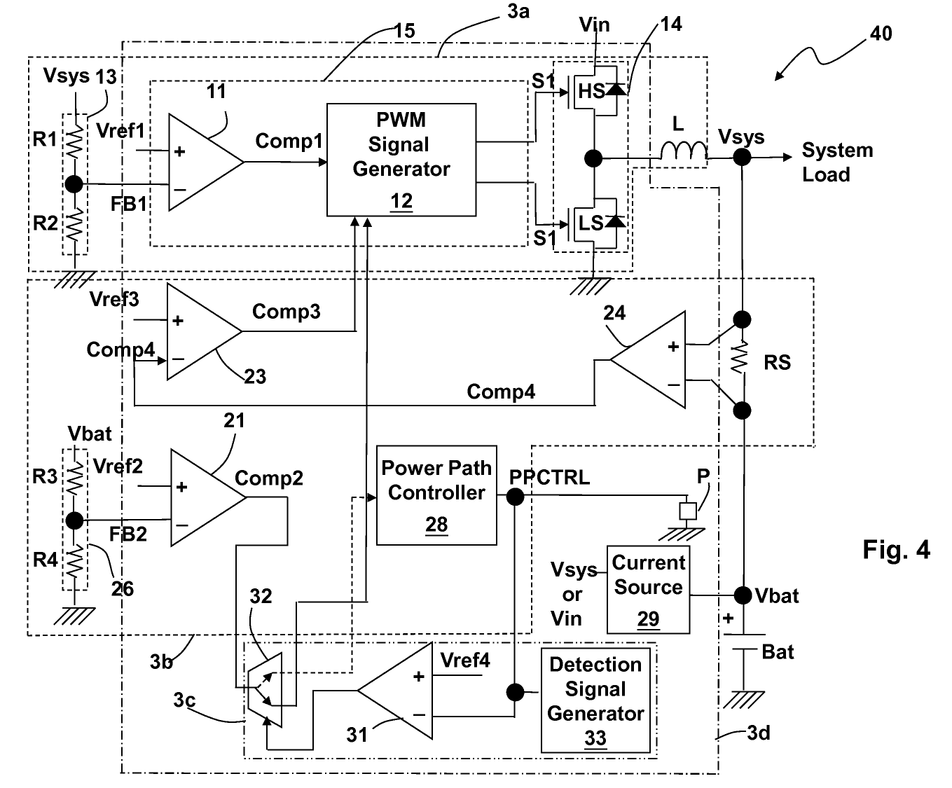

FIG. 3 shows a schematic diagram of an embodiment of the present invention, illustrating a multi-purpose power management chip applied to a power supply system. FIG. 4 shows a schematic diagram of the multi-purpose power management chip in FIG. 3 applied to another power supply system. Referring to FIGS. 3 and 4, these figures show that the multi-purpose power management chip 3d of the present invention can be applied to different applications to match with different printed circuit boards in use. That is, the chip 3d is not only suitable for the configuration where the battery Bat is connected to the output terminal through the sensing resistor RS, as shown in FIG. 1, but it is also suitable for the configuration where the battery Bat is connected to the output terminal Vsys through the sensing resistor RS and the PMOS transistor 27, as shown in FIG. 2. Examples of such applications are respectively shown in FIGS. 3 and 4. The multi-purpose power management chip 3d can detect which configuration it is applied to by various ways. In one embodiment, this can be manually set by an external signal. In another embodiment, the multi-purpose power management chip 3d has a pin which is designed for connecting to a power path power transistor PP in one configuration (the pin is not connected to the power path power transistor PP in the other configuration), and the potential of this pin can be used to detect which configuration the multi-purpose power management chip 3d is connected to automatically.

Referring to FIG. 3, the power supply system 30 comprises a switching regulator 3a, a power path management circuit 3b, a battery Bat, a power path power transistor PP (which is shown to be a PMOS transistor as an example; certainly, it can be an NMOS transistor instead), a current source and a path selection circuit 3c. The switching regulator 3a controls the power conversion between an input terminal Vin and an output terminal Vsys. The power path management circuit 3b controls the charging operation from the output terminal Vsys to the battery Bat. The path selection circuit 3c designates the information related to the battery voltage Vbat of the battery Bat to be fed back to the switching regulator 3a or the charging management circuit 3b according to whether the power path power transistor PP is disposed between the output terminal Vsys and the battery Bat.

More specifically, the switching regulator 3a converts external power from the input terminal Vin to the output terminal Vsys. The output terminal supplies power to the system load and charges the battery Bat. When the input terminal Vin is disconnected from the external power, the battery Bat will output power to the output terminal Vsys. In the configuration of the power supply system 30, a power path power transistor PP is disposed between the output terminal Vsys and the battery Bat. The power supply system 30 detects the battery voltage Vbat of the battery Bat to control the ON/OFF of the power path power transistor PP. When the battery voltage Vbat of the battery Bat is smaller than a predetermined level, the power path management circuit 3b turns OFF the power path power transistor PP, thereby preventing the voltage at the output terminal Vsys from being affected by the battery voltage Vbat and preventing the voltage at the output terminal Vsys from being too low. Under such circumstance, a current source 29 will be turned ON. The current source 29 provides a charging current from an appropriate voltage source. That is, the current source 29 can supply a current to the battery Bat from, for example but not limited to, the output terminal Vsys or the input terminal Vin. Thus, the battery Bat is charged through the current source 29. Under such situation, the switching regulator 3a simply converts the external power from the input terminal Vin to the output terminal Vsys. The output terminal Vsys simply outputs the converted power to the system load but does not charge the battery Bat through the power path power transistor PP. When the battery voltage of the battery is larger than or equal to the above-mentioned predetermined level, the power path management circuit 3b turns ON the power path power transistor PP, and the current source 29 is turned OFF. As a consequence, the current source 29 does not supply a current to the battery Bat. Under such situation, the battery Bat is charged through the power path power transistor PP and the switching regulator 3a. That is, under such situation, the switching regulator 3a first converts the external power from the input terminal Vin to the output terminal. Then, the output terminal Vsys not only supplies the converted power to the system load but also charges the battery Bat through the power path power transistor PP.

In the configuration of the power supply system 30, since the output terminal Vsys is coupled to the battery Bat through the power path power transistor PP, the path selection circuit 3c selects the power path management circuit 3b to receive the information related to the battery voltage Vbat of the battery Bat, thereby determining whether the battery Bat is charged through the switching regulator 3a or the current source 29. On the other hand, the switching regulator 3a controls the power conversion between the input terminal Vin and the output terminal Vsys according to the output voltage at the output terminal Vsys and the information related to the battery charging current. A feedback circuit 13 includes two resistors R1 and R2 connected to each other in series. One terminal of the resistor R1 is coupled to the output voltage at the output terminal Vsys, and one terminal of the resistor R2 is coupled to the ground. The feedback signal FB1 is the voltage difference across the resistor R2. In the switching regulator 3a, an error amplifier 11 receives the feedback signal FB1, and compares the feedback signal FB1 with a reference voltage Vref1 to generate an error signal Comp1 as an input to a PWM signal generator 12. This error signal Comp1 represents the information of the output voltage at the output terminal Vsys. In the power path management circuit 3b, an error amplifier 24 detects the voltage difference across the sensing resistor RS and outputs an error signal Comp4. An error amplifier 23 compares the error signal Comp4 with a reference voltage Vref3 to output an error signal Comp3. This error signal Comp3 represents the information of the battery charging current. As shown in FIG. 3, because the multiplexer 32 of the path selection circuit 3c selects the output path to a power path controller 28 (in the power path management circuit 3b) rather than the output path to the switching regulator 3a (the details of the path selection circuit 3c will be explained below), the PWM signal generator 12 of the switching regulator 3a does not receive the error signal Comp2, and the PWM signal generator 12 generates a switch signal S1 to operate the power transistor HS and the power transistor LS according to the error signal Comp1 and the error signal Comp3 (these two signals represent the information of the output voltage Vsys at the output terminal Vsys and the information of the battery charging current, respectively). By the operation of the power transistor HS and the power transistor LS, the input voltage Vin at the input terminal Vin is converted to a current through the inductor L. The output terminal Vsys supplies output current to power the system load and charge the battery (when the power path power transistor PP is turned ON), or it simply powers the system load (when the power path power transistor PP is turned OFF). The power transistor HS and the power transistor LS form a switch circuit 14. The error amplifier 11 and the PWM signal generator 12 form a switch control circuit 15.

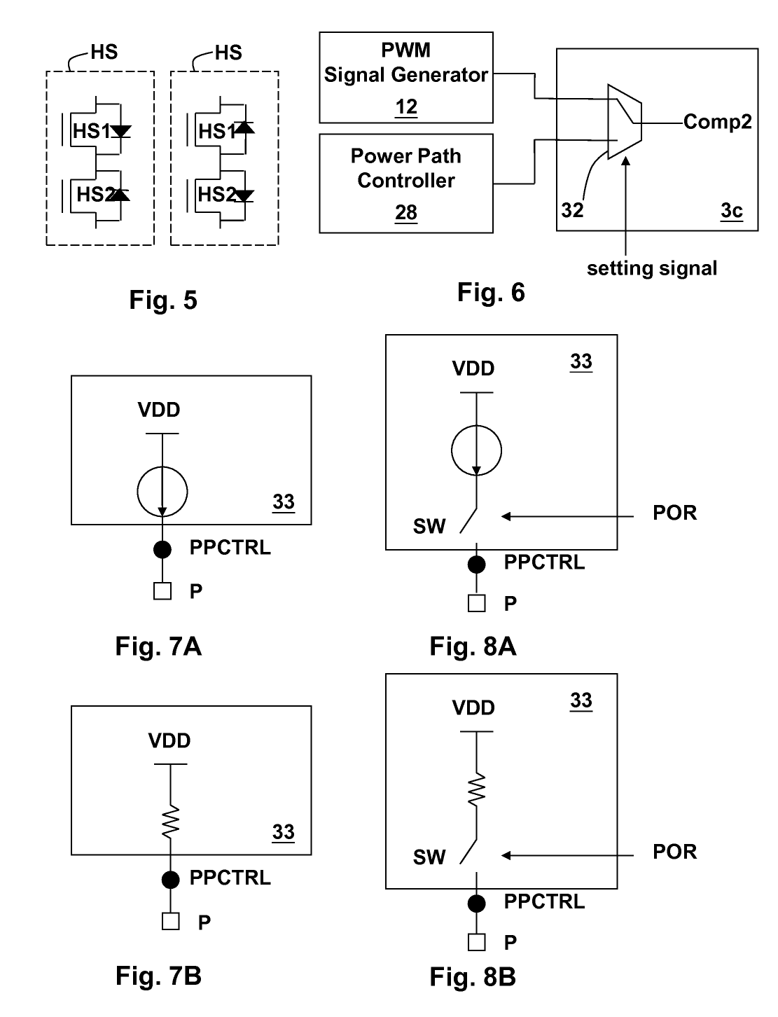

In certain applications of the present invention, it is required to protect the input voltage Vin, so that a reverse current is prevented from flowing from the output terminal Vsys toward the input terminal Vin through the power transistor HS. Hence, in another embodiment of the present invention, the power transistor HS in FIG. 3 can be replaced by two power transistors HS1 and HS2 connected in series. Each of the two power transistors HS1 and HS2 connected in series has a parasitic diode whose polarity is opposite to the other, as shown in FIG. 5, so that the reverse current flowing from the output terminal Vsys toward the input terminal Vin is blocked. That is, the switch signal S1 outputted by the PWM signal generator 12 concurrently controls the two power transistors HS1 and HS2 connected in series (or at least controls one of the two power transistors which has a parasitic diode whose polarity is opposite to the flowing direction of the current).

A feedback circuit 26 includes two resistors R3 and R4 connected to each other in series. One terminal of the resistor R3 is coupled to the battery voltage Vbat of the battery Bat, and one terminal of the resistor R4 is coupled to the ground. The feedback signal FB2 is the voltage difference across the resistor R4. In the power path management circuit 3b, an error amplifier 21 receives the feedback signal FB2, and compares the feedback signal FB2 with a reference voltage Vref2 to generate an error signal Comp2. Because the output terminal Vsys is coupled to the battery Bat through the power path power transistor PP, the multiplexer 32 of the path selection circuit 3c selects the output path to the power path controller 28. As a result, according to the error signal Comp2 representing the information of the battery voltage Vbat, the power path controller 28 determines whether the battery Bat is charged from the switching regulator 3a or is charged from the current source 29, and a switch signal S2 is generated accordingly to turn ON or turn OFF the power path power transistor PP. More specifically, when the battery voltage Vbat of the battery Bat is smaller than a predetermined level (such situation will be reflected by the error signal Comp2), the switch signal S2 generated by the power path controller 28 according to the error signal Comp2 will turn OFF the power path power transistor PP. Under such circumstance, the switching regulator 3a does not charge the battery Bat but simply supplies power to the system load. The battery Bat is charged through the current source 29. On the other hand, when the battery voltage Vbat of the battery Bat is larger than or equal to the predetermined level (such situation will also be reflected by the error signal Comp2), the switch signal S2 will turn ON the power path power transistor PP. Under such circumstance, the current source 29 will be turned OFF, and the switching regulator 3a not only supplies power to the system load but also charges the battery Bat.

In this embodiment, the path selection circuit 3c includes a comparator 31, a multiplexer 32 and a detection signal generator 33. The detection signal generator 33 generates a detection signal, which detects the status of the external connection with the pin P through the output node PPCTRL of the power path controller 28 and the pin P. As shown in FIG. 3, because the pin P is connected to the power path power transistor PP, the detection signal generated from the detection signal generator 33 will generate a relatively higher voltage at the output node PPCTRL. The negative input terminal of the comparator 31 receives this voltage generated by the detection signal, and the comparator 31 compares it with a reference voltage Vref4 to output a control signal to the multiplexer 32 such that a transmission path is selected for the error signal Comp2. The path selection circuit 3c sets the path selection preferably only when the system just starts or reboots, so that when the system 30 is in a normal operation status, the condition of the output node PPCTRL of the power path controller 28 does not affect the path selection circuit 3c. In one embodiment, when the power supply system 30 is turned ON, a POR (Power-On-Reset) signal is generated and it can be used as an enable signal to control the comparator 31 and/or the detection signal generator 33. After the power supply system 30 is completely turned ON, the comparator 31 and/or the detection signal generator 33 is disabled, so the selection made by the multiplexer 32 is fixed, and will not be interfered by the variation of the voltage at the node PPCTRL.

In the configuration of FIG. 4, as compared with FIG. 3, the system load of the power supply system 40 is connected to the battery Bat through only the sensing resistor RS without the power path power transistor PP in between, and hence, the pin P for the output node PPCRRL of the power path controller 28 is grounded. The negative input terminal of the comparator 31 is also coupled to the ground. The comparator 31 compares its negative input terminal with the reference voltage Vref4 (the positive input terminal), and outputs a control signal to the multiplexer 32 so that the multiplexer 32 selects to send the error signal Comp2 to the PWM signal generator 12 of the switching regulator 3a. Consequently, the PWM signal generator 12 generates the switch signal S1 according to the error signal Comp1 (representing the information related to the output voltage at the output terminal Vsys), the error signal Comp2 (representing the information related to the battery voltage Vbat) and the error signal Comp3 (representing the information related to the battery charging current). As compared with the power supply system in FIG. 3, the power path selection circuit 3c of the power supply system 40 selects the switching regulator 3a rather than the power path management circuit 3b to receive information related to the battery voltage Vbat of the battery Bat. In one embodiment, the switch control circuit 15, the switch circuit 14, the error amplifiers (11, 21, 23, and 24), the power path controller 28 and the path selection circuit 3c can be integrated into a multi-purpose power management chip 3d. Moreover, the multi-purpose power management chip 3d is suitable for the configuration where the battery Bat is connected to the output terminal Vsys through the power path power transistor PP and the sensing resistor RS, as shown in FIG. 3, and is also suitable for the configuration where the battery Bat is connected to the output terminal Vsys through the sensing resistor RS only, as shown in FIG. 4. However, the circuits and the devices included in the multi-purpose power management chip 3d are not limited by the above embodiment. For example, if the power transistors in the switch circuit 14 are high voltage devices, they can be located outside of the multi-purpose power management chip 3d and are not integrated therein.

How present invention is applied to different types of applications regardless whether the system load is directly or indirectly connected to the battery will be summarized as follow:

1. When the output terminal Vsys is coupled to the battery Bat through a power path power transistor PP (as shown in FIG. 3):

the path selection circuit 3c selects the power path management circuit 3b to receive information related to the battery voltage Vbat of the battery Bat, and:

(a) when the battery voltage Vbat of the battery Bat is smaller than a predetermined level, the power path controller 28 turns OFF the power path power transistor PP, and the current source 29 is turned ON. The battery 29 is, therefore, charged through the current source 29. Under such circumstance, the switching regulator 3a does not charge the battery Bat through the power path power transistor PP but simply supplies power to the system load;

(b) when the battery voltage Vbat of the battery Bat is larger than or equal to the predetermined level, the power path controller 28 turns ON the power path power transistor PP, and the current source 29 is turned OFF. The battery 29 is, therefore, charged through the switching regulator 3a. Under such circumstance, the switching regulator 3a not only supplies power to the system load but also charges the battery Bat.

Under the two above-mentioned circumstances, the switch regulator 3a controls the power conversion between the input terminal Vin and the output terminal Vout according to the output voltage at the output terminal Vsys (the error signal Comp1) and the battery charging current (the error signal Comp3).

2. When the output terminal Vsys is not coupled to the battery Bat through a power path power transistor PP (as shown in FIG. 4):

the path selection circuit 3c selects the switching regulator 3a to receive information related to the battery voltage Vbat of the battery Bat (the error signal Comp2). The battery 29 is charged through the switching regulator 3a. Under such circumstance, the switching regulator 3a not only supplies power to the system load but also charges the battery Bat. The switch regulator 3a controls the power conversion between the input terminal Vin and the output terminal Vout according to the output voltage Vsys at the output terminal Vsys (the error signal Comp1), the battery voltage Vbat of the battery Bat (the error signal Comp2) and the battery charging current (the error signal Comp3).

The foregoing embodiment is an example to illustrate that the path selection circuit 3c can automatically detect whether the power path power transistor PP is disposed in the charging path to the battery Bat, and determine to feed back the battery voltage Vbat of the battery Bat to the switching regulator 3a or the power path management circuit 3b accordingly. However, this is not the only way to make the path selection. As shown in FIG. 6, another way is to provide a setting signal from the external of the multi-purpose power management chip 3d, to set the feedback path of the battery voltage Vbat of the battery Bat. In this embodiment, it suffices for the path selection circuit 3c to include only the multiplexer 32.

FIGS. 7A-7B show two embodiments illustrating examples of the detection signal generator 33. As shown by the examples, the detection signal generator 33 can be a weak current source or a resistor whose upper terminal is connected to a suitable voltage (for example but not limited to a chip operation voltage VDD), and whose lower terminal is coupled to the output node PPCTRL (pin P) of the power path controller 28. When the system starts or reboots, if the pin P is coupled to the power path power transistor PP, the detection signal generator 33 will raise the voltage of the output node PPCTRL. On the other hand, if the pin P is grounded, the detection signal generator 33 cannot raise the voltage of the node PPCTRL. Thus, the connection of the pin P can be differentiated. When the system is in a normal operation status, the voltage of the output node PPCTRL is dominated by the output of the power path controller 28, and is not affected by the detection signal generator 33.

FIGS. 8A-8B show two other embodiments illustrating examples of the detection signal generator 33. In these two embodiments, the detection signal generator 33 further includes a switch SW which is turned ON by the power-on reset signal POR. When the system enters the normal operation status after booting, the switch SW is turned OFF to reduce power consumption.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, a device which does not substantially influence the primary function of a signal can be inserted between any two devices in the shown embodiments, such as a switch. For another example, the positive and negative input terminals of an error amplifier circuit or a comparator are interchangeable, with corresponding amendments of the circuits processing these signals. For yet another example, the power transistors HS, HS1, HS2 and LS and the power path power transistor PP can be a PMOS or an NMOS. For still another example, the present invention is also applicable to the configuration where there is no resistor RS between the output terminal Vsys and the battery Bat for sensing the battery charging current (that is, the output terminal is directly connected to the battery Bat). The multi-purpose power management chip 3d of the present invention can be applied to such configuration and the input terminal of the error amplifier 24 can be grounded or floating. In view of the foregoing, the spirit of the present invention should cover all such and other modifications and variations, which should be interpreted to fall within the scope of the following claims and their equivalents.

What is claimed is:

1. A multi-purpose power management chip for controlling a power conversion from an input terminal to an output terminal and for controlling a charging operation to a battery from the output terminal, the multi-purpose power management chip comprising:
a switch circuit including at least one power transistor;
a switch control circuit for generating a first switch signal which controls an operation of the power transistor to thereby control the power conversion from the input terminal to the output terminal;
a power path management circuit for controlling the charging operation from the output terminal to the battery;
a current source for supplying a current to the battery to charge the battery; and
a path selection circuit for determining whether the charging operation to the battery is controlled by the power path management circuit and the current source or not;
wherein:
when the output terminal is coupled to the battery through a power path power transistor, the path selection circuit designates the power path management circuit to control the power path power transistor, thereby controlling the charging operation to the battery; and
when the output terminal is not coupled to the battery through the power path power transistor, the path selection circuit selects the switch control circuit to receive information related to a battery voltage of the battery.

2. The multi-purpose power management chip of claim 1, wherein:
when the output terminal is coupled to the battery through the power path power transistor and when the battery voltage of the battery is smaller than a predetermined level, the power path management circuit turns OFF the power path power transistor; and
when the output terminal is coupled to the battery through the power path power transistor and when the battery voltage of the battery is larger than or equal to the predetermined level, the power path management circuit turns ON the power path power transistor.

3. The multi-purpose power management chip of claim 2, wherein:
when the battery voltage of the battery is smaller than the predetermined level and when the power path power transistor is turned OFF, the current source is turned ON to supply the current to the battery; and
when the battery voltage of the battery is larger than or equal to the predetermined level and when the power path power transistor is turned ON, the current source is turned OFF.

4. The multi-purpose power management chip of claim 1, wherein when the output terminal is not coupled to the battery through the power path power transistor, the current source is turned OFF.

5. The multi-purpose power management chip of claim 1, wherein the path selection circuit includes a multiplexer which determines whether the charging operation to the battery is controlled by the power path management circuit and the current source or not according to an external setting signal.

6. The multi-purpose power management chip of claim 1, wherein the path selection circuit includes:
a detection signal generator for generating a detection voltage according to whether the power path power transistor is disposed between the output terminal and the battery;
a comparator for comparing the detection voltage with a reference voltage; and
a multiplexer for determining whether the charging operation to the battery is controlled by the power path management circuit and the current source according to an output from the comparator.

7. The multi-purpose power management chip of claim 1, wherein the power path management circuit includes:
a first error amplifier for comparing a first feedback signal related to the battery voltage with a first reference voltage to generate a first error signal, wherein the path selection circuit determines whether to transmit the first error signal to the switch control circuit or the power path management circuit; and
a second error amplifier for comparing information related to the battery charging current with a second reference voltage to generate a second error signal.

8. The multi-purpose power management chip of claim 7, wherein the power path management circuit further includes a power path controller; when the path selection circuit determines to transmit the first error signal to the power path management circuit, the power path controller generates a second switch signal which controls an operation of the power path power transistor; when the path selection circuit does not determine to transmit the first error signal to the power path management circuit, the power path controller does not generate the second switch signal which controls the operation of the power path power transistor.

9. The multi-purpose power management chip of claim 7, wherein the switch control circuit includes:
a third error amplifier for comparing a second feedback signal related to an output voltage at the output terminal with a third reference voltage to generate a third error signal; and
a pulse width modulation (PWM) signal generator,
wherein:
when the path selection circuit determines to transmit the first error signal to the power path management circuit, the PWM signal generator generates the first switch signal according to the second error signal and the third error signal; and
when the path selection circuit determines to transmit the first error signal to the switch control circuit, the PWM signal generator generates the first switch signal according to the first error signal, the second error signal and the third error signal.

10. A power path control circuit for selecting at least one control loop according to a connection relationship between an output terminal and a battery, the power path control circuit comprising:
a power path management circuit for controlling a charging operation to the battery from an output voltage at the output terminal, wherein the output voltage is converted from an input voltage at an input terminal through a switching regulator;
a current source for supplying a current to the battery to charge the battery; and
a path selection circuit for determining whether the charging operation to the battery is controlled by the power path management circuit and the current source or not according to whether a power path power transistor is disposed between the output terminal and the battery;
wherein:
when the output terminal is coupled to the battery through the power path power transistor, the path selection circuit designates the power path management circuit to control the power path power transistor, thereby controlling the charging operation to the battery; and
when the output terminal is not coupled to the battery through the power path power transistor, the path selection circuit selects the switching regulator to receive information related to a battery voltage of the battery.

11. The power path control circuit of claim 10, wherein:
when the output terminal is coupled to the battery through the power path power transistor and when the battery voltage of the battery is smaller than a predetermined level, the power path management circuit turns OFF the power path power transistor; and
when the output terminal is coupled to the battery through the power path power transistor and when the battery voltage of the battery is larger than or equal to the predetermined level, the power path management circuit turns ON the power path power transistor.

12. The power path control circuit of claim 10, wherein:
when the battery voltage of the battery is smaller than the predetermined level and when the power path power transistor is turned OFF, the current source is turned ON to supply the current to the battery; and
when the battery voltage of the battery is larger than or equal to the predetermined level and when the power path power transistor is turned ON, the current source is turned OFF.

13. The power path control circuit of claim 10, wherein when the output terminal is not coupled to the battery through the power path power transistor, the current source is turned OFF.

14. The power path control circuit of claim 10, wherein the path selection circuit includes:
a detection signal generator for generating a detection voltage according to whether the power path power transistor is disposed between the output terminal and the battery;
a comparator for comparing the detection voltage with a reference voltage; and
a multiplexer for determining whether the charging operation to the battery is controlled by the power path management circuit and the current source according to an output from the comparator.
